(19) United States
(12) Patent Application Publication
(10) Pub. No.: US 2014/0164847 A1
(43) Pub. Date: Jun. 12, 2014

(54) Internal Logic Analyzer with Programmable Window Capture

(71) Applicant: NVIDIA CORPORATION, Santa Clara, CA (US)

(72) Inventors: Peter C. Mills, San Jose, CA (US); Gautam Bhatia, Mountain View, CA (US)

(73) Assignee: NVIDIA Corporation, Santa Clara, CA (US)

(21) Appl. No.: 13/707,396

(22) Filed: Dec. 6, 2012

(51) Int. Cl. G06F 11/34

(52) U.S. Cl. CPC G06F 11/34
USPC 714/45

(57) ABSTRACT

One embodiment includes receiving a data signal transmitted to the processing unit, analyzing the data signal and generating feedback information related to the data signal, and capturing the data signal via a write enable during a plurality of clock cycles specified by a programmable controller included within the processing unit. One advantage of the disclosed technique is that the programmable controller can be used to set the capture window for one or more hardwired triggers included within the processing unit. Further, the programmable controller is able to set up additional triggers that separate and apart from the hardwired triggers included within the processing unit and set the capture window for those triggers. Thus, the disclosed technique provides a highly flexible and adaptive approach for capturing and storing on-chip data and feedback information that can be analyzed later when performing diagnostic and debugging operations.

### BACKGROUND OF THE INVENTION

1. Field of the Invention

The present invention relates generally to the field of integrated circuit interface debugging and, more specifically, to an internal logic analyzer with programmable window capture.

2. Description of the Related Art

Debugging tools for integrated circuits (also referred to herein as “chips”), such as internal logic analyzers (ILAs), are configured to capture the history of logical events that occur within an integrated circuit or an interface to an integrated circuit and store that history on the integrated circuit for later access and analysis. When later accessed, developers and persons responsible for trouble shooting the chip can inspect the history of logical events and, from that history, try to debug problems occurring within the logic of the integrated circuit. This approach to integrated circuit and interface analysis has proven quite helpful in silicon debugging, where logic errors and the like oftentimes cannot be seen or detected by inspecting the silicon.

Traditional ILAs utilize a trigger-based design, where a number of hard-wired triggers enable certain designated events to be captured and stored in a designated on-chip memory. One drawback to traditional ILAs is that the associated triggers are hard-wired into the integrated circuit when the integrated circuit is initially designed. With such an approach, the triggers cannot be changed once the chip has taped out, and new triggers cannot be added to the chip. Consequently, when using a traditional ILA to debug part of an integrated circuit or an interface to an integrated circuit, one cannot gain any information regarding the operation of the integrated circuit or interface outside of specific history of logic events captured by the hard-wired triggers. There is no way to change or dynamically control or configure the types of events being captured or the time period over which different events are being captured.

As the foregoing illustrates, what is needed in the art is a more flexible approach to chip interface debugging using ILAs.

### SUMMARY OF THE INVENTION

One embodiment of the present invention sets forth a method for capturing debug data within a processing unit. The method includes receiving a data signal transmitted to the processing unit, analyzing the data signal and generating feedback information related to the data signal, and capturing the data signal via a write enable during a plurality of clock cycles specified by a programmable controller included within the processing unit.

One advantage of the disclosed technique is that the programmable controller can be used to set the capture window for one or more hardwired triggers included within the processing unit. Further, the programmable controller is able to set up additional triggers that are separate and apart from the hardwired triggers included within the processing unit and set the capture window for those triggers. Thus, the disclosed technique provides a highly flexible and adaptive approach for capturing and storing on-chip data and feedback information that can be analyzed later when performing diagnostic and debugging operations.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating a computer system configured to implement one or more aspects of the present invention;

FIG. 2 illustrates a parallel processing subsystem 112, according to one embodiment of the present invention.

FIG. 3 is a block diagram of a processing unit chip with an internal logic analyzer, according to one embodiment of the present invention; and

FIG. 4 is a more conceptual diagram of the processing unit chip of FIG. 3 with an internal logic analyzer, according to one embodiment of the present invention.

FIG. 5 is a flow diagram of method steps for capturing debug data within a processing unit, according to one embodiment of the present invention.

### DETAILED DESCRIPTION

In the following description, numerous specific details are set forth to provide a more thorough understanding of the present invention. However, it will be apparent to one of skill in the art that the present invention may be practiced without one or more of these specific details. In other instances, well-known features have not been described in order to avoid obscuring the present invention.

### System Overview

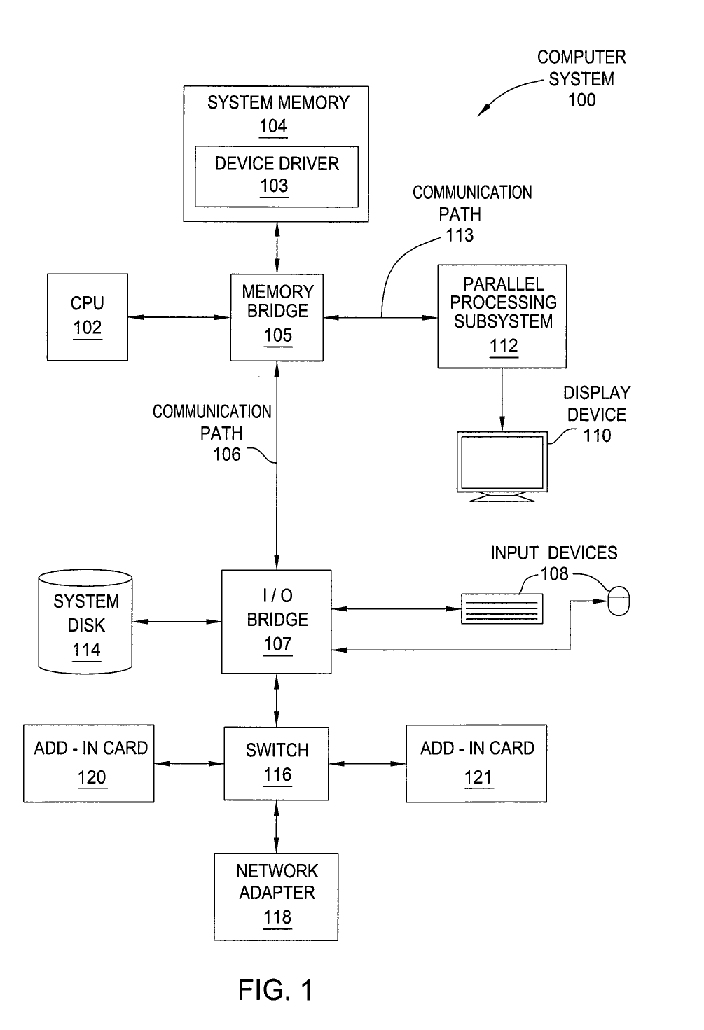

FIG. 1 is a block diagram illustrating a computer system 100 configured to implement one or more aspects of the present invention. Computer system 100 includes a central processing unit (CPU) 102 and a system memory 104 communicating via an interconnection path that may include a memory bridge 105. Memory bridge 105, which may be, e.g., a Northbridge chip, is connected via a bus or other communication path 106 (e.g., a HyperTransport link) to an I/O (input/output) bridge 107. I/O bridge 107, which may be, e.g., a Southbridge chip, receives user input from one or more user input devices 108 (e.g., keyboard, mouse) and forwards the input to CPU 102 via path 106 and memory bridge 105. A parallel processing subsystem 112 is coupled to memory bridge 105 via a bus or other communication path 113 (e.g., a PCI Express, Accelerated Graphics Port, or HyperTransport link); in one embodiment parallel processing subsystem 112 is a graphics subsystem that delivers pixels to a display device 110 (e.g., a conventional CRT or LCD based monitor). A system disk 114 is also connected to I/O bridge 107. A switch 116 provides connections between I/O bridge 107 and other components such as a network adapter 118 and various add-in cards 120 and 121. Other components (not explicitly shown), including USB or other port connections, CD drives, DVD drives, film recording devices, and the like, may also be connected to I/O bridge 107. Communication paths interconnecting the various components in FIG. 1 may be implemented using any suitable protocols, such as PCI (Peripheral Component Interconnect), PCI-Express, AGP (Accelerated Graphics Port), HyperTransport, or any other bus or point-to-point communication protocol(s), and connections between different devices may use different protocols as is known in the art.

The system memory 104 includes an application program and device driver 103. The application program generates calls to a graphics API in order to produce a desired set of results, typically in the form of a sequence of graphics images. The application program also transmits one or more high-level shading programs to the graphics API for processing within the device driver 103. The high-level shading programs are typically source code text of high-level programming instructions that are designed to operate on one or more shaders within the parallel processing subsystem 112. The graphics API functionality is typically implemented within the device driver 103.

In one embodiment, the parallel processing subsystem 112 incorporates circuitry optimized for graphics and video processing, including, for example, video output circuitry, and constitutes a graphics processing unit (GPU). In another embodiment, the parallel processing subsystem 112 incorporates circuitry optimized for general purpose processing, while preserving the underlying computational architecture, described in greater detail herein. In yet another embodiment, the parallel processing subsystem 112 may be integrated with one or more other system elements, such as the memory bridge 105, CPU 102, and I/O bridge 107 to form a system on chip (SoC).

It will be appreciated that the system shown herein is illustrative and that variations and modifications are possible. The connection topology, including the number and arrangement of bridges, the number of CPUs 102, and the number of parallel processing subsystems 112, may be modified as desired. For instance, in some embodiments, system memory 104 is connected to CPU 102 directly rather than through a bridge, and other devices communicate with system memory 104 via memory bridge 105 and CPU 102. In other alternative topologies, parallel processing subsystem 112 is connected to I/O bridge 107 or directly to CPU 102, rather than to memory bridge 105. In still other embodiments, I/O bridge 107 and memory bridge 105 might be integrated into a single chip. Large embodiments may include two or more CPUs 102 and two or more parallel processing systems 112. The particular components shown herein are optional; for instance, any number of add-in cards or peripheral devices might be supported. In some embodiments, switch 116 is eliminated, and network adapter 118 and add-in cards 120, 121 connect directly to I/O bridge 107.

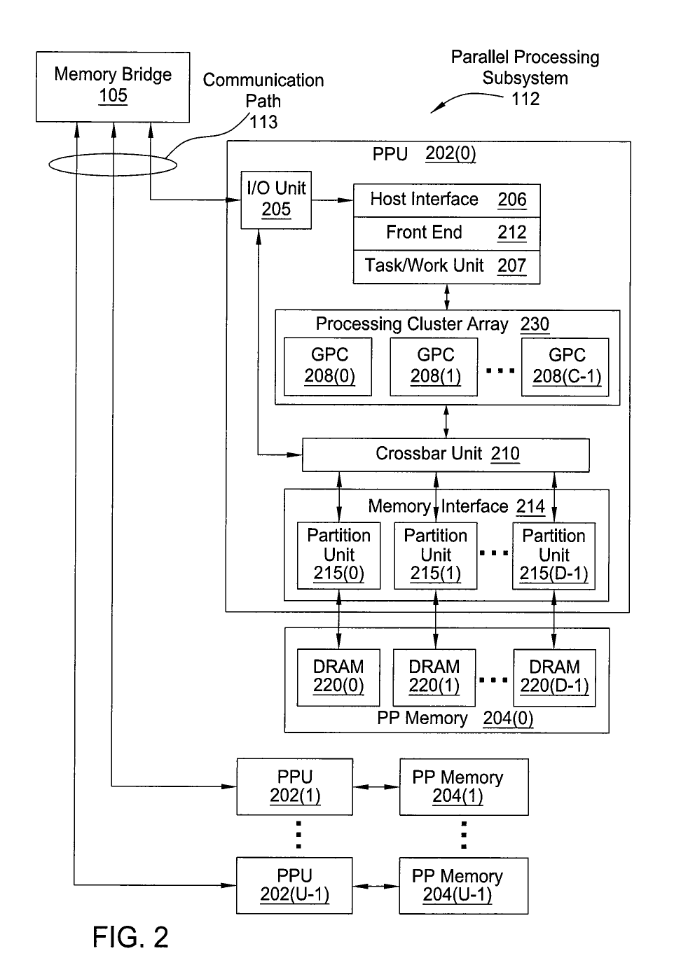

FIG. 2 illustrates a parallel processing subsystem 112, according to one embodiment of the present invention. As shown, parallel processing subsystem 112 includes one or more parallel processing units (PPUs) 202, each of which is coupled to a local parallel processing (PP) memory 204. In general, a parallel processing subsystem includes a number U of PPUs, where U≧1. (Herein, multiple instances of like objects are denoted with reference numbers identifying the object and parenthetical numbers identifying the instance where needed.) PPUs 202 and parallel processing memories 204 may be implemented using one or more integrated circuit devices, such as programmable processors, application specific integrated circuits (ASICs), or memory devices, or in any other technically feasible fashion.

Referring again to FIG. 1, in some embodiments, some or all of PPUs 202 in parallel processing subsystem 112 are graphics processors with rendering pipelines that can be configured to perform various tasks related to generating pixel data from graphics data supplied by CPU 102 and/or system memory 104 via memory bridge 105 and bus 113, interacting with local parallel processing memory 204 (which can be used as graphics memory including, e.g., a conventional frame buffer) to store and update pixel data, delivering pixel data to display device 110, and the like. In some embodiments, parallel processing subsystem 112 may include one or more PPUs 202 that operate as graphics processors and one or more other PPUs 202 that are used for general-purpose computations. The PPUs may be identical or different, and each PPU may have its own dedicated parallel processing memory device(s) or no dedicated parallel processing memory device(s). One or more PPUs 202 may output data to display device 110 or each PPU 202 may output data to one or more display devices 110.

In operation, CPU 102 is the master processor of computer system 100, controlling and coordinating operations of other system components. In particular, CPU 102 issues commands that control the operation of PPUs 202. In some embodiments, CPU 102 writes a stream of commands for each PPU 202 to a push buffer (not explicitly shown in either FIG. 1 or FIG. 2) that may be located in system memory 104, parallel processing memory 204, or another storage location accessible to both CPU 102 and PPU 202. PPU 202 reads the command stream from the push buffer and then executes commands asynchronously relative to the operation of CPU 102.

Referring back now to FIG. 2, each PPU 202 includes an I/O (input/output) unit 205 that communicates with the rest of computer system 100 via communication path 113, which connects to memory bridge 105 (or, in one alternative embodiment, directly to CPU 102). The connection of PPU 202 to the rest of computer system 100 may also be varied. In some embodiments, parallel processing subsystem 112 is implemented as an add-in card that can be inserted into an expansion slot of computer system 100. In other embodiments, a PPU 202 can be integrated on a single chip with a bus bridge, such as memory bridge 105 or I/O bridge 107. In still other embodiments, some or all elements of PPU 202 may be integrated on a single chip with CPU 102.

In one embodiment, communication path 113 is a PCI-EXPRESS link, in which dedicated lanes are allocated to each PPU 202, as is known in the art. Other communication paths may also be used. An I/O unit 205 generates packets (or other signals) for transmission on communication path 113 and also receives all incoming packets (or other signals) from communication path 113, directing the incoming packets to appropriate components of PPU 202. For example, commands related to processing tasks may be directed to a host interface 206, while commands related to memory operations (e.g., reading from or writing to parallel processing memory 204) may be directed to a memory crossbar unit 210. Host interface 206 reads each push buffer and outputs the work specified by the push buffer to a front end 212.

Each PPU 202 advantageously implements a highly parallel processing architecture. As shown in detail, PPU 202(0) includes a processing cluster array 230 that includes a number C of general processing clusters (GPCs) 208, where C 1. Each GPC 208 is capable of executing a large number (e.g., hundreds or thousands) of threads concurrently, where each thread is an instance of a program. In various applications, different GPCs 208 may be allocated for processing different types of programs or for performing different types of computations. For example, in a graphics application, a first set of GPCs 208 may be allocated to perform tessellation operations and to produce primitive topologies for patches, and a second set of GPCs 208 may be allocated to perform tessellation shading to evaluate patch parameters for the primitive topologies and to determine vertex positions and other per-vertex attributes. The allocation of GPCs 208 may vary dependent on the workload arising for each type of program or computation.

GPCs 208 receive processing tasks to be executed via a work distribution unit 207, which receives commands defining processing tasks from front end unit 212. Processing tasks include indices of data to be processed, e.g., surface (patch) data, primitive data, vertex data, and/or pixel data, as well as state parameters and commands defining how the data is to be processed (e.g., what program is to be executed). Work distribution unit 207 may be configured to fetch the indices corresponding to the tasks, or work distribution unit 207 may receive the indices from front end 212. Front end 212 ensures that GPCs 208 are configured to a valid state before the processing specified by the push buffers is initiated.

When PPU 202 is used for graphics processing, for example, the processing workload for each patch is divided into approximately equal sized tasks to enable distribution of the tessellation processing to multiple GPCs 208. A work distribution unit 207 may be configured to produce tasks at a frequency capable of providing tasks to multiple GPCs 208 for processing. By contrast, in conventional systems, processing is typically performed by a single processing engine, while the other processing engines remain idle, waiting for the single processing engine to complete its tasks before beginning their processing tasks. In some embodiments of the present invention, portions of GPCs 208 are configured to perform different types of processing. For example a first portion may be configured to perform vertex shading and topology generation, a second portion may be configured to perform tessellation and geometry shading, and a third portion may be configured to perform pixel shading in screen space to produce a rendered image. Intermediate data produced by GPCs 208 may be stored in buffers to allow the intermediate data to be transmitted between GPCs 208 for further processing.

Memory interface 214 includes a number D of partition units 215 that are each directly coupled to a portion of parallel processing memory 204, where D≧1. As shown, the number of partition units 215 generally equals the number of DRAM 220. In other embodiments, the number of partition units 215 may not equal the number of memory devices. Persons skilled in the art will appreciate that DRAM 220 may be replaced with other suitable storage devices and can be of generally conventional design. A detailed description is therefore omitted. Render targets, such as frame buffers or texture maps may be stored across DRAMs 220, allowing partition units 215 to write portions of each render target in parallel to efficiently use the available bandwidth of parallel processing memory 204.

Any one of GPCs 208 may process data to be written to any of the DRAMs 220 within parallel processing memory 204. Crossbar unit 210 is configured to route the output of each GPC 208 to the input of any partition unit 215 or to another GPC 208 for further processing. GPCs 208 communicate with memory interface 214 through crossbar unit 210 to read from or write to various external memory devices. In one embodiment, crossbar unit 210 has a connection to memory interface 214 to communicate with I/O unit 205, as well as a connection to local parallel processing memory 204, thereby enabling the processing cores within the different GPCs 208 to communicate with system memory 104 or other memory that is not local to PPU 202. In the embodiment shown in FIG. 2, crossbar unit 210 is directly connected with I/O unit 205. Crossbar unit 210 may use virtual channels to separate traffic streams between the GPCs 208 and partition units 215.

Again, GPCs 208 can be programmed to execute processing tasks relating to a wide variety of applications, including but not limited to, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel shader programs), and so on. PPUs 202 may transfer data from system memory 104 and/or local parallel processing memories 204 into internal (on-chip) memory, process the data, and write result data back to system memory 104 and/or local parallel processing memories 204, where such data can be accessed by other system components, including CPU 102 or another parallel processing subsystem 112.

A PPU 202 may be provided with any amount of local parallel processing memory 204, including no local memory, and may use local memory and system memory in any combination. For instance, a PPU 202 can be a graphics processor in a unified memory architecture (UMA) embodiment. In such embodiments, little or no dedicated graphics (parallel processing) memory would be provided, and PPU 202 would use system memory exclusively or almost exclusively. In UMA embodiments, a PPU 202 may be integrated into a bridge chip or processor chip or provided as a discrete chip with a high-speed link (e.g., PCI-EXPRESS) connecting the PPU 202 to system memory via a bridge chip or other communication means.

As noted above, any number of PPUs 202 can be included in a parallel processing subsystem 112. For instance, multiple PPUs 202 can be provided on a single add-in card, or multiple add-in cards can be connected to communication path 113, or one or more of PPUs 202 can be integrated into a bridge chip. PPUs 202 in a multi-PPU system may be identical to or different from one another. For instance, different PPUs 202 might have different numbers of processing cores, different amounts of local parallel processing memory, and so on. Where multiple PPUs 202 are present, those PPUs may be operated in parallel to process data at a higher throughput than is possible with a single PPU 202. Systems incorporating one or more PPUs 202 may be implemented in a variety of configurations and form factors, including desktop, laptop, or handheld personal computers, servers, workstations, game consoles, embedded systems, and the like.

### Internal Logic Analyzer with Programmable Window Capture

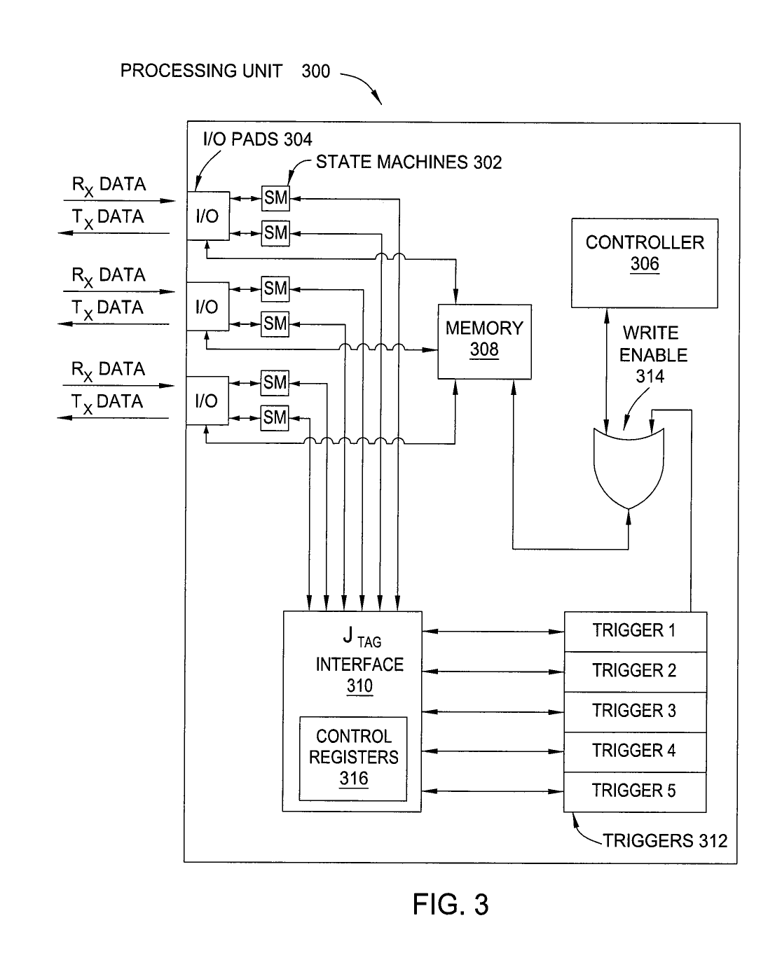

FIG. 3 is a block diagram of a processing unit 300 with an internal logic analyzer (ILA), according to one embodiment of the present invention. As shown, the processing unit chip 300 includes state machines 302, input/output pads (I/O) 304, a controller 306, a memory 308, a Jtag interface 310, hardwired triggers 312, and a write enable 314.

According to some embodiments, processing unit 300 may be any one of the parallel processing units (PPUs) 202 of FIG. 2. In operation, receive (Rx) data is transmitted to processing unit 300 via I/O pads 304 on the processing unit 300. Each I/O pad 304 is associated with a number of state machines 302. The state machines 302 are adaptation loops that look at the Rx data and provide feedback to manage the signal quality of the Rx data being received via the I/O pads 304. Rx data is received at the I/O pads during each cycle. Each clock cycle is 50 ps. Over many cycles data can drift with changes in temperature, voltage, process variation, humidity, etc. The state machines 302 evaluate the edge and center eye of the data signal and provide feedback about whether to shift the clock or change voltage levels to improve the signal quality of the Rx data. Because this feedback information is internal to the chip, both the feedback information and the Rx data can be saved to memory 308, which is a history RAM, where the information and data can be later downloaded and analyzed for debugging purposes. In some embodiments, transmitted (Tx) data may be sent from the I/O pads 304 and analyzed in the same manner by the state machines 302.

Triggers 312 are logic equations hardwired onto processing unit 300. As shown, multiple triggers 312 can be hardwired onto the processing unit 300. For example, a first hardwired trigger 312 may be “start capture if 0000 is seen.” Another second example hardwired trigger 312 may be “begin capture when Rx data is received.” Another third example hardwired trigger 312 may be “begin capture when there is an error.” Each trigger 312 activates based on the hardwired logic. When activated, a trigger 312 directs write enable 314 on the memory 308 to write the Rx data and the feedback information to memory 308 over a fixed number of clock cycles equivalent to the capture period specified by the trigger 312. Memory 308 may be 128 bit wide history RAM. In some embodiments, memory 308 may be any other desired size.

Jtag interface 310 provides an interface for controlling one or more control registers 316, which may be privileged (PRIV registers), that are programmable through software. The Jtag interface 310 allows for selection of triggers 312 to be used as well as selection of data to be captured. The triggers 312 are hardwired onto the processing unit 300 during the design phase and cannot be changed after the processing unit 300 has taped out. Nonetheless, the triggers 312 are selectable using the Jtag interface 310. In some embodiments, more than one hardwired trigger 312 may be selected by the Jtag interface 310. For example, any combination of triggers 1, 2, 3, 4, and 5 may be selected by the Jtag interface 310, but no other triggers 312 can be used or added. This allows some flexibility in capturing the Rx data because various hardwired triggers 312 may be selected to capture Rx data at various times, however, the selection is still limited to the periods covered by each of the triggers 312 previously hardwired on the processing unit 300 during the design phase with no ability to capture Rx data during periods not covered by triggers 312.

Jtag interface 310 is configured to select data from one or more of the state machines 302 to be stored on memory 308 during various capture cycles when the write enable 314 is activated by any one of the triggers 312. For example, in some embodiments, memory 308 is 128 bits wide and the Jtag interface 310 uses data select to determine which 128 bits of data will be stored on memory 308 during cycles when write enable 314 is activated. In some embodiments, the data select may be different for reads and writes.

Controller 306, which may be a UController, is programmable and allows a user direct control of event capture during times not covered by hardwired triggers 312. The controller 306 gives commands, e.g., a receive command, a transmit command, or a capture debug data command to the write enable 314. The controller 306 is configurable to operate independently of triggers 312 as another trigger and/or may activate write enable 314 also activated by one of the hardwired triggers to define a capture window as the union of the hardwired trigger 312 capture period and the capture period specified by the controller 306. Controller 306 may also be used to capture any other window configured by controller 306.

In some embodiments, the controller 306 may be programmed to transmit a capture debug data command for a specified number of clock cycles after or before a hardwired trigger 312 event. For example, in the example case where trigger 1 is hardwired as “start capture if 0000 is seen,” the controller 306 may command the write enable 314 to capture selected data during a window of cycles before or after that event. In this case, debug data will be captured in memory 308 during a period of cycles defined by the activated hardwired trigger 312 and during the period of cycles dynamically specified by the controller 306. The period defined by the hardwired trigger 312 may overlap entirely or in part with the period specified by the controller 306. In some embodiments, the controller 306 can act as an additional dynamic trigger. For example, the controller 306 can directly command write enable 314 to capture data during the first N cycles of a bus transfer, stop capture for the next M cycles, and then resume capture for another L cycles. Such capture may be initiated even if there were no hardwired triggers 312 or other event detected marking the start of a bus transfer. In other embodiments, any other combinations of windows for starting and stopping capture may be specified.

In one example implementation, expected Rx data may comprise 0001, but 0000 is seen. In this example case, the controller 306 may be programmed to start window capture a number cycles before or after where 0000 was seen. Using this debug data, it can be determined whether the state machine 302 is incorrect. In addition, according to some embodiments, the controller 306 may receive feedback and be programmed to start a capture window based on the feedback, i.e., upon detecting a particular event. In one embodiment, controller 306 may be implemented within processing unit 300 with no other hardwired triggers 312 present.

The controller 306 with programmable window capture may be used anywhere a controller is used to control the flow of events. In another embodiment, the controller 306 may be used capture instruction events in memory 308 to be used for instruction decode, instead of capturing I/O data.

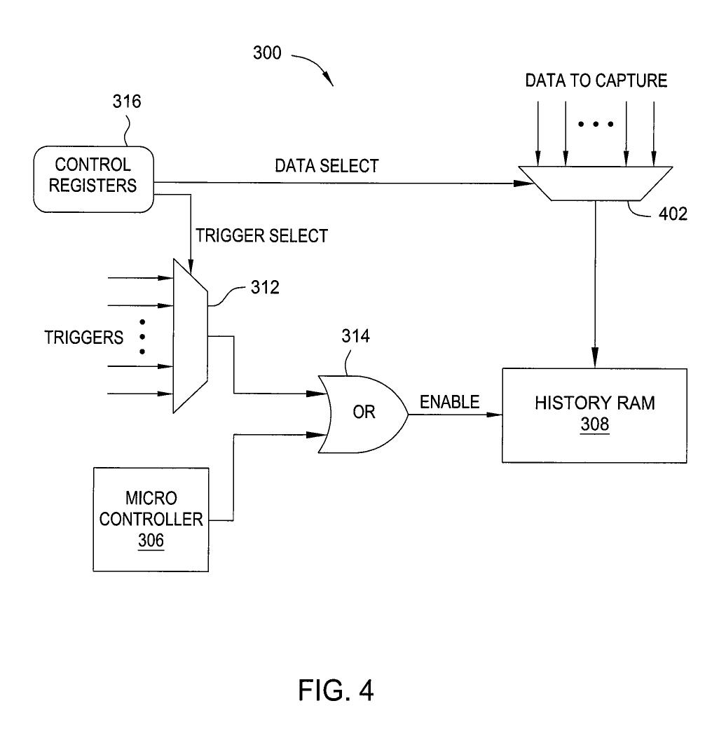

FIG. 4 is a more conceptual diagram of the processing unit 300 of FIG. 3 with an internal logic analyzer, according to one embodiment of the present invention. Again, as shown, the processing unit chip 300 includes control registers 316, hardwired triggers 312, controller 306, write enable 314, and history RAM 308. Also shown is an input multiplexer 402 that may be designed to include state machines 302 and I/O pads 304. In operation, the control registers 316, which are programmable and may be controlled by Jtag interface 310, are configurable to select data entering input multiplexer 402. As such, when write enable 314 is activated, only the selected data (e.g., data from certain I/O pads 304 or state machines 302) is written on memory 308.

As previously explained herein, control registers 316 are further configurable to select which of triggers 312 are to be enabled. Each trigger 312 is a hardwired piece of logic. When enabled, a trigger 312 activates write enable 314 when the logic event occurs. When write enable 314 is activated by a trigger 312, write enable 314 allows the input data from input 402 selected by the control registers 316 to be written to history RAM 308 during a given number of clock cycles (i.e., the capture window) defined by the hardwired trigger 312.

Alternatively, controller 306 is configurable to also activate write enable 314 and dynamically specify a number of clock cycles for data capture (i.e., the capture window). Like triggers 312, controller 306 activates write enable 314 to enable the input data from input 402 selected by the control registers 316 to be written to history RAM 308 during a specified window. In some embodiments, where write enable 314 is activated by both a hardwired trigger 312 and the controller 306, the capture window is defined by the number of clock cycles defined by the hardwired trigger 312 and the window specified by the controller 306. In some embodiments, controller 306 may also be used as a trigger independently of triggers 312, where controller 306 (i) sends a capture debug data command to write enable 314 without any trigger or logic event being detected and (ii) specifies a number of clock cycles for the capture window. In some embodiments, controller 306 may be configured to send such a capture debug command to write enable 314 upon occurrence of a particular trigger event.

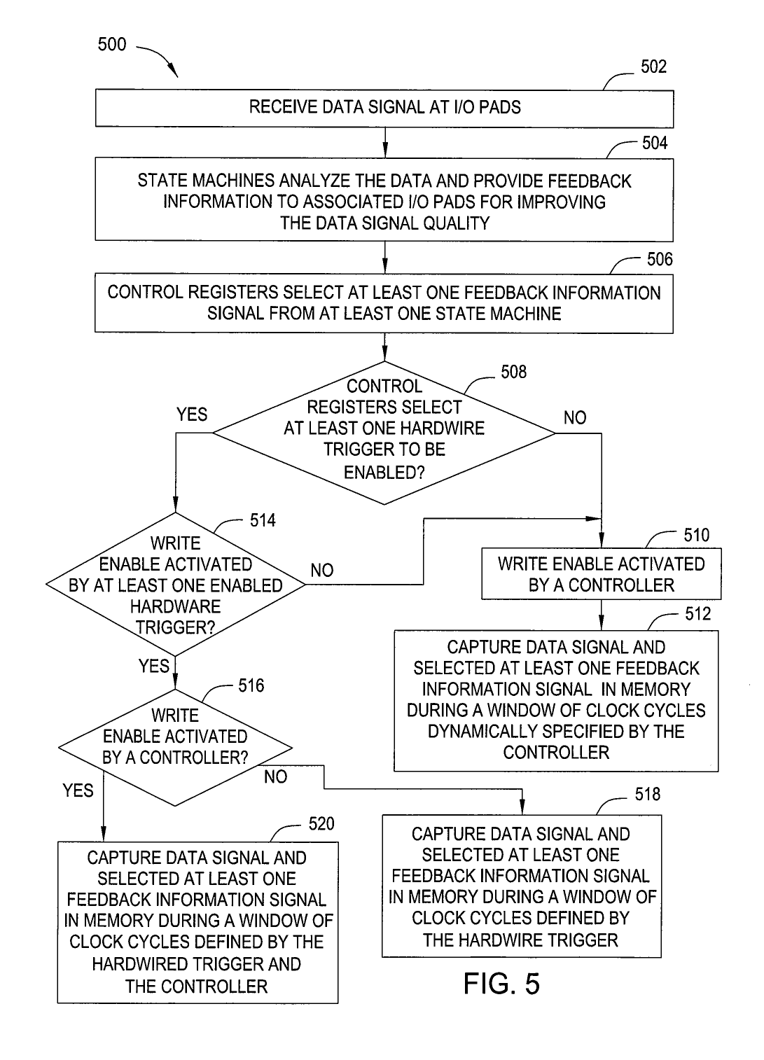

FIG. 5 sets forth a flow diagram of method steps for capturing debug data, according to one embodiment of the present invention. Although the method steps are described in conjunction with the system for FIGS. 1-4, persons skilled in the art will understand that any system configured to perform the method steps, in any order, is within the scope of the invention.

As shown, the method 500 begins at step 502, where I/O pads 304 receive a data signal. At step 504, one or more state machines 302 associated with the I/O pads analyze the data and provide feedback information to the one or more I/O pads 304 for improving the data signal quality. At step 506, the control registers 316 select at least one feedback information signal from at least one of the state machines 302.

At step 508, there is a determination regarding whether the control registers 316 select at least one of the hardwired triggers 312 to be enabled. If not, then at step 510, the controller 306 can activate the write enable 314 to capture the data and the selected feedback information signal. The controller 306 can simply activate the write enable 314 at a particular programmed point in time, or the controller 306 can activate the write enable in response to detecting a particular programmed trigger event. At step 512, the data and feedback information signal are captured and stored in history RAM 308 for a number of clock cycles specified by the controller 306 for the capture window.

Returning now to step 508, if the control registers 316 are to select at least one of the hardwired triggers 312 to be enabled, then, at step 514, there is a determination regarding whether one of the enabled hardwired triggers 312 activates the write enable 314 to capture the data and the selected feedback information signal. The hardwired trigger 312 activates the write enable 314 upon detecting the particular trigger event associated with that hardwired trigger 312. If not, then at step 510, the controller 306 can activate the write enable 314 to capture the data and the selected feedback information signal and at step 512, the data and feedback information signal are captured and stored in history RAM 308 for a number of clock cycles specified by the controller 306 for the capture window.

Returning now to step 514, if one of the enabled hardwired triggers 312 actives the write enable 314, then at step 516, there is a determination regarding whether the controller 306 also activates the write enable 314. If so, then at step 520, the data and feedback information signal are captured and stored in history RAM 308 for a number of clock cycles defined by the controller 306 and the activated hardwired trigger 312 for the capture window. If not, however, then at step 518, the data and feedback information signal are captured and stored in history RAM 308 for a number of clock cycles for the capture window specified by selected hardwired trigger 312 that activated the write enable 314.

In sum, as set forth herein, a processor is implemented with a programmable microcontroller that allows tailored window capture as well as tailored trigger specification. In one embodiment, the processor includes a control register, an on-chip memory, a data write device, and a microcontroller. The control register is configured to select data and hardwired triggers of interest. The microcontroller is configurable to enable the data write device to write the selected data of interest to the memory during a specified number of clock cycles. In some embodiments the data microcontroller and a hardwired trigger both initiate data capture during a capture window defined by the hardwired trigger window and a window dynamically specified by the microcontroller. Alternatively, the microcontroller may specify a capture window for a certain type of data separate and independent of the data captured according to the hardwired triggers. In yet another embodiment, the microcontroller may specify a capture window upon occurrence of an event. All captured data is stored in the memory and can be accessed or downloaded at a later time. Thus, the configurable microcontroller allows for dynamic capture of logical events for use in chip interface or chip debugging.

One advantage of the disclosed technique is that the programmable controller can be used to set the capture window for one or more hardwired triggers included within the processing unit. Further, the programmable controller is able to set up additional triggers that separate and apart from the hardwired triggers included within the processing unit and set the capture window for those triggers. Thus, the disclosed technique provides a highly flexible and adaptive approach for capturing and storing on-chip data and feedback information that can be analyzed later when performing diagnostic and debugging operations.

The techniques above have been described above with reference to specific embodiments. Persons skilled in the art, however, will understand that various modifications and changes may be made thereto without departing from the broader spirit and scope of the technique as set forth in the appended claims. The foregoing description and drawings are, accordingly, to be regarded in an illustrative rather than a restrictive sense.

We claim:

1. A method for capturing debug data within a processing unit, the method comprising:
receiving a data signal transmitted to the processing unit;
analyzing the data signal and generating feedback information related to the data signal; and
capturing the data signal via a write enable during a plurality of clock cycles specified by a programmable controller included within the processing unit.

2. The method of claim 1, further comprising capturing the feedback information during the plurality of clock cycles.

3. The method of claim 1, further comprising storing the captured data signal in an on-chip memory included within the processing unit.

4. The method of claim 1, further comprising activating the write enable.

5. The method of claim 4, wherein the write enable is activated by a hardwired trigger included within the processing unit in response to a trigger event associated with the hardwired trigger.

6. The method of claim 5, wherein at least one control register selects the hardwired trigger to be enabled.

7. The method of claim 4, wherein the write enable is activated by the programmable controller.

8. The method of claim 7, wherein the programmable controller activates the write enable at a programmed point in time.

9. The method of claim 7, wherein the programmable controller activates the write enable in response to detecting a programmed trigger event.

10. A subsystem configured to capture debug data, the subsystem comprising:
a memory;
a state machine configured to receive a data signal and generate feedback information related to the data signal;
a programmable controller configured to specify a plurality of clock cycles during which the data signal is to be captured; and
a write enable configured to allow the data signal to be transmitted to the memory for storage during the plurality of clock cycles.

11. The subsystem of claim 10, wherein the write enable is further configured to allow the feedback information to be transmitted to the memory for storage during the plurality of clock cycles.

12. The subsystem of claim 10, further comprising a hardwired trigger that is configured to activate the write enable in response to a trigger event associated with the hardwired trigger.

13. The subsystem of claim 12, further comprising at least one control register configured to select the hardwired trigger to be enabled.

14. The subsystem of claim 10, wherein the programmable controller is further configured to activate the write enable.

15. The subsystem of claim 14, wherein the programmable controller is configured to activate the write enable at a programmed point in time.

16. The subsystem of claim 14, wherein the programmable controller is configured to activate the write enable in response to detecting a programmed trigger event.

17. A processing unit, comprising:
a subsystem configured to capture data and including:
a memory;
a state machine configured to receive a data signal and generate feedback information related to the data signal;
a programmable controller configured to specify a plurality of clock cycles during which the data signal is to be captured; and
a write enable configured to allow the data signal to be transmitted to the memory for storage during the plurality of clock cycles.

18. The processing unit of claim 17, further comprising a hardwired trigger that is configured to activate the write enable in response to a trigger event associated with the hardwired trigger.

19. The processing unit of claim 17, wherein the programmable controller is further configured to activate the write enable.

20. The processing unit of claim 19, wherein the programmable controller is configured to activate the write enable at a programmed point in time.

21. The processing unit of claim 19, wherein the programmable controller is configured to activate the write enable in response to detecting a programmed trigger event.
